(19) United States
(12) Patent Application Publication
(10) Pub. No.: US 2017/0312980 A1
(43) Pub. Date: Nov. 2, 2017

(54) 3D-OBJECT PRODUCTION SYSTEM, 3D-OBJECT PRODUCTION DEVICE, LAYERING MEMBER, 3D OBJECT, 3D-OBJECT PRODUCTION METHOD, AND PROGRAM

(71) Applicant: KEIO UNIVERSITY, Minato-ku, Tokyo (JP)

(72) Inventors: Hiroya TANAKA, Kanagawa (JP); Tsuneo MASUDA, Kanagawa (JP)

(73) Assignee: KEIO UNIVERSITY, Minato-ku, Tokyo (JP)

(21) Appl. No.: 15/523,486

(22) PCT Filed: Oct. 29, 2015
(86) PCT No.: PCT/JP2015/080607

§ 371 Date: May 1, 2017

(30) Foreign Application Priority Data
Nov. 4, 2014 (JP) 2014-224351

(51) Int. Cl. B29C 64/106; B29C 64/223; B33Y 70/00; B33Y 50/02; B33Y 30/00; B29C 64/393; B33Y 10/00

(52) U.S. Cl. CPC B29C 64/106; B29C 64/393; B29C 64/223; B33Y 10/00; B33Y 50/02; B33Y 30/00; B33Y 70/00

(57) ABSTRACT

A 3D-object production system equipped with a layering sheet or a reference 3D-formed object, and a 3D production device. The layering sheet is provided with information pertaining to the 3D object, and serves as a member used in the layering of the object. In addition, the reference 3D-formed object serves as a reference 3D object equipped with information pertaining to the 3D object. The 3D-object production device reads the 3D object information from the layering sheet or the reference 3D-formed object, and on the basis of the read 3D object information, layers and forms the 3D object.

### TECHNICAL FIELD

The present invention relates to a 3D-object production system to be used in forming 3D objects, a 3D-object production device, a layering member, a 3D object, a 3D-object production method, and a storage medium.

### BACKGROUND ART

Devices called 3D printers are known as devices that produce 3D objects. An additive manufacturing method is known as one method for forming three-dimensional 3D objects with these devices. For example, Patent Document 1 recites a method that uses an additive manufacturing technology to represent architectural structures. When a 3D object is to be formed in this kind of 3D printer, data to be used in forming the target 3D object is inputted.

Hence, the target 3D object may be repeatedly produced with ease.
Patent Document 1: Japanese Unexamined Patent Application (Translation of PCT Application), Publication No. 2013-507679

### DISCLOSURE OF THE INVENTION

A 3D object that is produced by a conventional 3D printer is realized on the basis of formation data. When users do not create this formation data themselves, it is necessary to obtain the data from a creator via a storage medium or a communications medium, or to download the data from the Internet or the like. Consequently, when a user sees a 3D object or a part thereof and wishes to produce the same object, or when a need to produce a 3D object arises, there is no simple way for the user to directly obtain the formation data.

That is, with conventional 3D-object production devices, data to be used in the formation of 3D objects has not been high in usability.

### Means for Solving the Problems

A 3D-object production system according to an aspect of the present invention includes: at least one of a layering member to be used in layering of a 3D object, the layering member being provided with information pertaining to the 3D object, or a reference 3D object that is provided with the information pertaining to the 3D object; and a 3D-object production device that reads the information pertaining to the 3D object from the layering member or reference 3D object and, on the basis of the read information pertaining to the 3D object, layers and forms the 3D object.

### Effects of the Invention

According to the present invention, the usability of data to be used in the formation of a 3D object by a 3D-object production device may be increased.

### BRIEF DESCRIPTION OF THE DRAWINGS

FIG. 1 is a schematic diagram illustrating a system configuration of a 3D-object production system according to an embodiment of the present invention.

FIG. 2A is a schematic view illustrating a structural example of a layering sheet.

FIG. 2B is a schematic view illustrating a structural example of a reference 3D-formed object in which an identification information medium is embedded.

FIG. 3 is a schematic view illustrating an external structure example of a 3D-object production device.

FIG. 4 is a sectional view schematically illustrating a structural example of a 3D printer head.

FIG. 5 is a flowchart depicting a flow of 3D-object production processing that is executed by the 3D-object production device.

FIG. 6 is a flowchart depicting a flow of formation data supply processing that is executed by a server.

FIG. 7 is a schematic view illustrating a state in which a 3D object has been formed on a layering sheet by the 3D-object production system.

FIG. 8 is a schematic view illustrating an example in which the 3D-object production device is constituted by a three-axis 3D printer.

### PREFERRED MODE FOR CARRYING OUT THE INVENTION

In the following, embodiments of the present invention are explained using the attached drawings.

### —Structure—

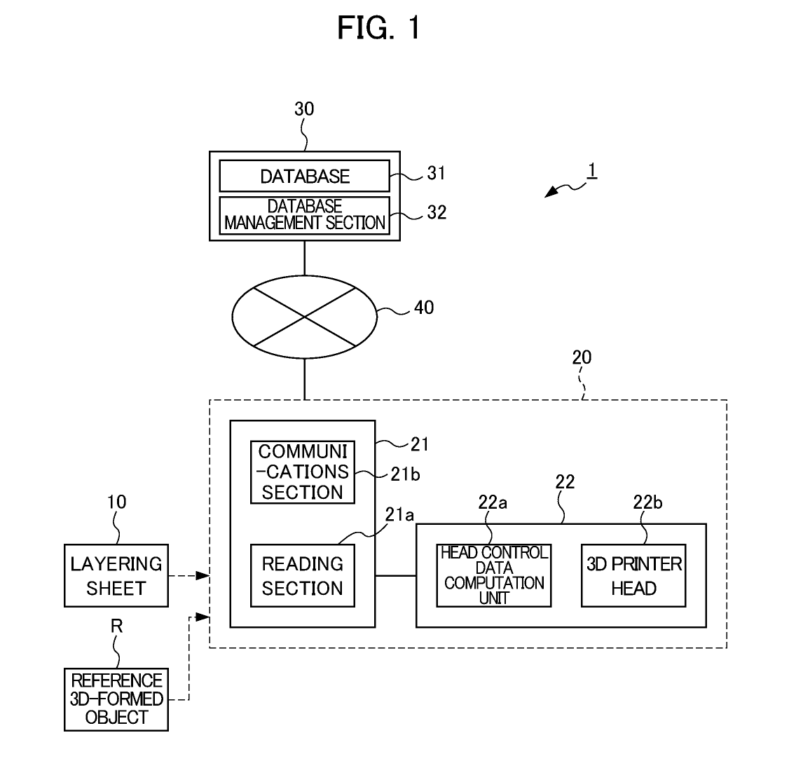

FIG. 1 is a schematic diagram illustrating a system configuration of a 3D-object production system 1 according to an embodiment of the present invention.
As illustrated in FIG. 1, the 3D-object production system 1 includes a layering sheet 10 (or a reference 3D-formed object R), a 3D-object production device 20 and a server 30. The 3D-object production device 20 and the server 30 are configured to be capable of communications via a network 40.

The layering sheet 10 is equipped with an RFID (radio frequency identification) tag 12 to which a URL (uniform resource locator) can be written and memorized to serve as identification information. The URL represents an acquisition source for formation data of a 3D object.

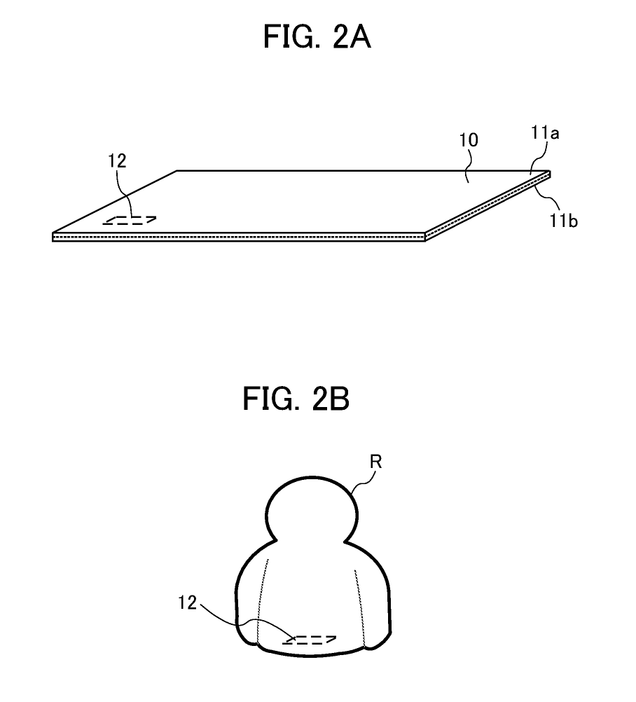

FIG. 2A is a schematic view illustrating a structural example of the layering sheet 10.
As illustrated in FIG. 2A, the layering sheet 10 is formed by two sheets 11a and 11b that are stuck together. The RFID tag 12 is sandwiched between the two sheets 11a and 11b. The sheet 11a of the layering sheet 10 includes a surface (a top face) on which a 3D object is to be formed. The top face is a rough surface and the sheet 11a is constituted with a material that features adhesiveness.
Instead of the RFID tag 12, the layering sheet 10 may be provided with identification information in a read-only form such as a one-dimensional barcode, a two-dimensional barcode or the like. An identification information medium such as the RFID tag 12 or the like may be structured integrally with the layering sheet 10 or may be structured to be detachable from the layering sheet 10. For example, it is possible to embed an identification information medium of a 3D-formed object in a bottom face of the formed object, thus forming a reference 3D-formed object R.
FIG. 2B is a schematic view illustrating a structural example of a reference 3D-formed object R in which an identification information medium is embedded.

As a material of the top face of the layering sheet 10, for example, the following can be mentioned: a liquid silicone composition such as a room temperature-curable liquid silicone composition, a thermosetting liquid silicone composition or the like; a gypsum slurry; a liquid composition containing a curable resin such as a phenol resin, an epoxy resin, a melamine resin, a urea resin, a polyurethane or the like (for example, a composition containing a curable resin and a solvent); a melt of a thermoplastic resin, a melt of a solid composition that includes a thermoplastic resin, or a liquid composition containing a thermoplastic resin (for example, a composition containing a thermoplastic resin and a solvent), in which the thermoplastic resin is a polyolefin (polyethylene, polypropylene, polycyclic olefin or the like), a polystyrene, an AS resin, an ABS resin, a polyvinyl chloride, a polyacrylonitrile, a (meth)acrylic resin, a cellulose-based resin, an elastomer, an aliphatic polyamide (nylon 6, nylon 6,6, nylon 12, nylon 6,12 or the like), an aromatic polyamide (MXD nylon or the like), an aromatic polyester resin (polyethylene terephthalate resin, polybutylene terephthalate resin, polyethylene naphthalate resin or the like), a polycarbonate, a polyacetal, a polyphenylene ether resin, a polyarylene sulfide (polyphenylene sulfide resin or the like), a polysulfone, a polyimide, a crystalline polymer (crystalline polyester, crystalline polyester amide, crystalline polyamide or the like), or the like; and so forth. Silicone-based compositions and gypsum slurry are preferable, of which silicone-based compositions are more preferable. As an example of a commercially available silicone-based composition, SILOPREN RTV-2K 1406 (manufactured by MOMENTIVE PERFORMANCE MATERIALS) or the like can be mentioned. As an example of a commercially available gypsum slurry, SL PLASTER (manufactured by YOSHINO GYPSUM CO., LTD.) or the like can be mentioned. A material using paper (in which paper tape is adhered to the top face of the layering sheet 10 or the like) is also usable as the material of the top face of the layering sheet 10.

Because this material is used, a first layer of a forming material that is ejected by the 3D-object production device 20 can easily be fixed to the top face of the layering sheet 10. Moreover, the top face of the layering sheet 10 may be provided with heat resistance and may be formed with the property that a 3D object can be easily detached when the 3D object is to be detached. Because this material is used, provided fixing characteristics of the top face of the layering sheet 10 can be assured, the top face of the layering sheet 10 need not be a rough surface.

As mentioned above, because the identification information representing a source for acquiring formation data of a 3D object is provided in the layering sheet 10, a 3D object that has been formed may itself be utilized as formation data. Therefore, an object produced by the 3D-object production device 20 may be distributed or the like as a 3D-formed object that is equipped with formation data. That is, the usability of data to be used in the formation of 3D objects may be increased. Further, in a state in which no 3D object has been formed, a 3D object represented by formation data may be effectively supplied by formation data that has been materially embodied in the layering sheet 10 being supplied. Therefore, modes of use of formation data may be expanded compared to the related art. Further yet, by the formation data of a 3D-formed object itself being stored and supplied in the 3D-formed object, copies of the 3D object may be produced easily. Thus, modes of use of the formation data may be expanded.

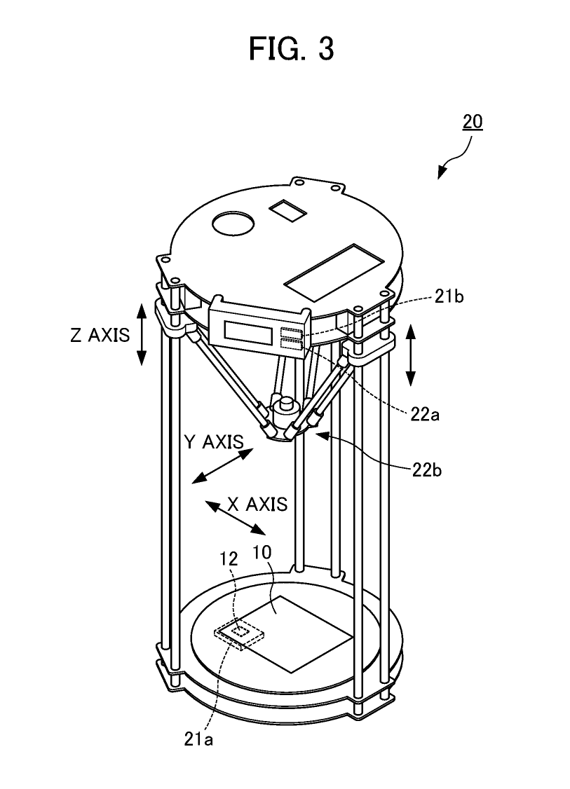

The 3D-object production device 20 is a “3D printer” capable of producing a 3D object by an additive manufacturing method. The 3D-object production device 20 may be constituted by, for example, a Delta-type (parallel-link) 3D printer. FIG. 3 is a schematic view illustrating an external structure example of the 3D-object production device 20. As illustrated in FIG. 3, a 3D printer head 22b of the 3D-object production device 20 is structured to be movable in an X-Y plane, defined by a stage on which the layering sheet 10 is disposed, and along a Z axis perpendicular to the X-Y plane.

A forming material is sequentially supplied to the 3D printer head 22b from a supply unit (not shown in the drawings) that supplies the forming material.

The 3D-object production device 20 reads a URL from the RFID tag 12 of the layering sheet 10 or reference 3D-formed object R, downloads formation data from the server 30 via the network 40, and uses the formation data to form a 3D object corresponding to the layering sheet 10 or the reference 3D-formed object R.

The layering sheet 10 disposed on the stage of the 3D-object production device 20 is in a state in which the top face thereof is horizontal. The layering sheet 10 is fixed to the stage so as not to shift in position during additive manufacturing, by suction at the rear face of the layering sheet 10, a fixing member or the like. The layering sheet 10 is positioned in the X and Y directions of the 3D-object production device 20 by the layering sheet 10 being disposed at a specified position on the stage or by the position of the layering sheet 10 being detected on the basis of images thereof captured by a camera.

As illustrated in FIG. 1, the 3D-object production device 20 is equipped with an ID reading device 21 and a 3D-object forming unit 22. The ID reading device 21 is connected with the 3D-object forming unit 22 via a USB (Universal Serial Bus) cable. Structures are possible in which the ID reading device 21 is incorporated into the 3D-object production device 20. The ID reading device 21 is provided with a reading section 21a and a communications section 21b.

The reading section 21a reads the URL memorized in the RFID tag 12 provided in the layering sheet 10 or reference 3D-formed object R, and outputs the URL to the communications section 21b. The communications section 21b sends a request for transmission of formation data through the network 40 to the server 30, specifying the URL inputted from the reading section 21a. The communications section 21b then receives 3D object formation data from the server 30 via the network 40 and outputs the formation data to the 3D-object forming unit 22.

The 3D-object forming unit 22 is equipped with a head control data computation unit 22a and the 3D printer head 22b. On the basis of the 3D object formation data inputted from the communications section 21b, the head control data computation unit 22a creates head control data for controlling the 3D printer head 22b. In specific terms, the head control data computation unit 22a divides the 3D object formation data into plural layers, defines two-dimensional shapes of the layers and, from data of the two-dimensional shape of each layer, generates control data for the 3D printer head 22b to form the layer. Thus, head control data is created for each layer, representing a path along which the 3D printer head 22b is moved and ejection positions and amounts of the forming material. In accordance with the head control data, the 3D printer head 22b moves in the horizontal plane of the layer and heats and ejects the forming material.

Thus, the 3D printer head 22b sequentially forms the two-dimensional shape of each layer.

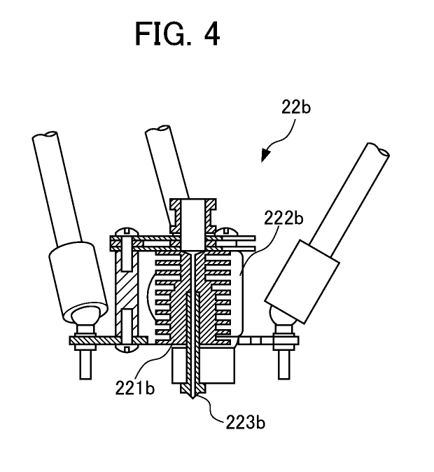

FIG. 4 is a sectional view schematically illustrating a structural example of the 3D printer head 22b.

As illustrated in FIG. 4, the 3D printer head 22b is equipped with a melting portion 221b, a fan 222b and a nozzle 223b. The melting portion 221b heats the supplied forming material, melting the forming material into a state in which the forming material can be ejected from the nozzle 223b. A thermoplastic resin such as, for example, a PLA (polylactic acid) resin, an ABS resin or the like may be used as the forming material.
The fan 222b cools heat produced by the melting portion 221b, suppressing the conduction of heat to other components.
The nozzle 223b ejects the forming material melted by the melting portion 221b, layering the forming material onto the layering sheet 10.

The server 30 is provided with a database 31 and a database management section 32.

The database 31 stores formation data to be used in the formation of 3D objects. The formation data may be, for example, data in the STL format, the AMF format or the like, or design data such as CAD data or the like. However, provided the formation data is in a format that can be used for the formation of a 3D object by the 3D-object production device 20, the formation data may be head control data, such as data in the G-code format representing movements of a printer head or the like, or may be data in an alternative format. The formation data may be encrypted for transmission and reception between the server 30 and the 3D-object production device 20. When the database management section 32 receives a request from the 3D-object production device 20 for the transmission of formation data with a specified URL, the database management section 32 reads formation data corresponding to the URL from the database 31 and transmits this formation data to the 3D-object production device 20 via the network 40. Thus, because the server 30 manages formation data with the database 31, it is possible to perform upgrades and the like of 3D object formation data without modifying the identification information at the layering sheet 10, by updating the formation data memorized in the database 31 as appropriate.

### —Operation—

Now, operations of the 3D-object production system 1 are described.

### —3D Object Production Processing—

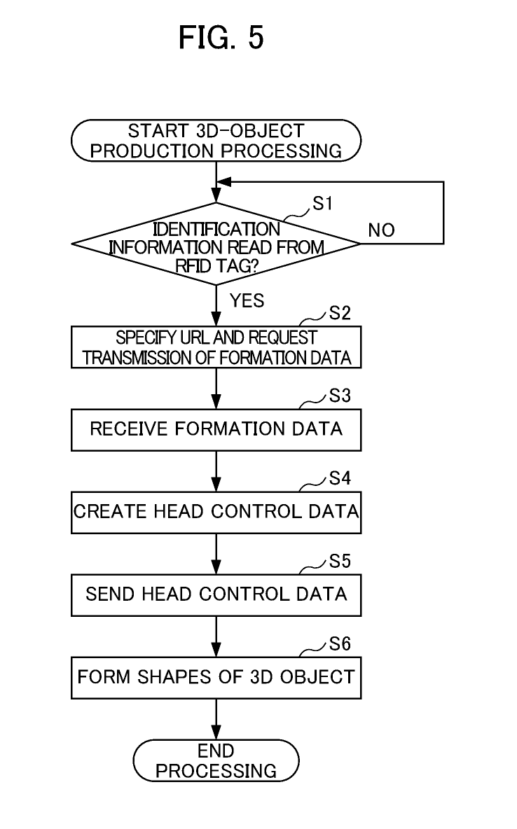

First, operations of the 3D-object production device 20 are described with reference to FIG. 5.
FIG. 5 is a flowchart depicting a flow of 3D-object production processing that is executed by the 3D-object production device 20.
The 3D-object production processing is started in response to an operation commanding the production of a 3D object being performed at the 3D-object production device 20.

In step S1, the reading section 21a makes a determination as to whether a URL memorized in the RFID tag 12 of the layering sheet 10 or reference 3D-formed object R has been read.

If no URL memorized in the RFID tag 12 of the layering sheet 10 or reference 3D-formed object R has been read, the result of the determination in step S1 is “NO” and the processing of step S1 is repeated.
On the other hand, when a URL memorized in the RFID tag 12 of the layering sheet 10 or reference 3D-formed object R has been read, the result of the determination in step S1 is “YES” and the processing proceeds to step S2.
In step S2, the communications section 21b sends a request for the transmission of formation data to the server 30, specifying the URL read by the reading section 21a.
In step S3, the communications section 21b receives formation data from the server 30.

In step S4, the head control data computation unit 22a creates head control data on the basis of the formation data received by the communications section 21b.

In step S5, the head control data computation unit 22a sends, to the 3D printer head 22b, control data representing a path along which the 3D printer head 22b is to be moved and ejection positions and amounts of the forming material.
In step S6, the 3D printer head 22b forms a three-dimensional shape in layers in accordance with the head control data. Herein, if the formation data is acquired from the layering sheet 10, the 3D object may be formed on the layering sheet 10, but if the formation data is acquired from a reference 3D-formed object R, the reference 3D-formed object R is removed from the stage and then the 3D object may be formed on a predetermined base or sheet. After step S6, the 3D-object production processing ends.

### —Formation Data Supply Processing—

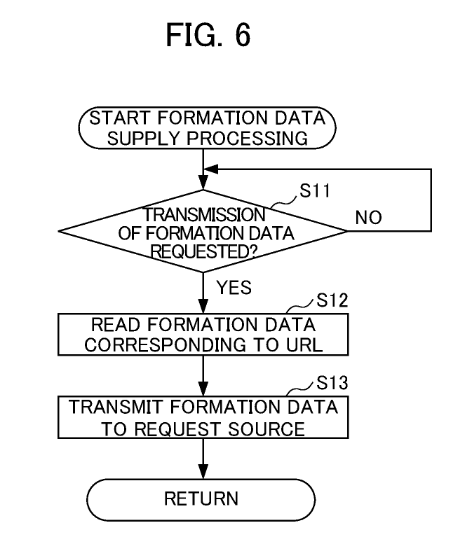

Now, operations of the server 30 are described with reference to FIG. 6.

FIG. 6 is a flowchart depicting a flow of formation data supply processing that is executed by the server 30.
The formation data supply processing is started in response to an operation commanding execution of the formation data supply processing being performed at the server 30.
In step S11, the database management section 32 makes a determination as to whether a request for transmission of formation data specifying a URL has been received from the 3D-object production device 20.
If there is no request from the 3D-object production device 20 for the transmission of formation data with a URL specified, the result of the determination in step S11 is “NO” and the processing of step S11 is repeated.
When there is a request from the 3D-object production device 20 for the transmission of formation data with a URL specified, the result of the determination in step S11 is “YES” and the processing proceeds to step S12.

In step S12, the database management section 32 reads formation data corresponding to the specified URL from the database 31.

In step S13, the database management section 32 transmits the read formation data to the 3D-object production device 20 that is the source of the request for the formation data. After step S13, the formation data supply processing is repeated.

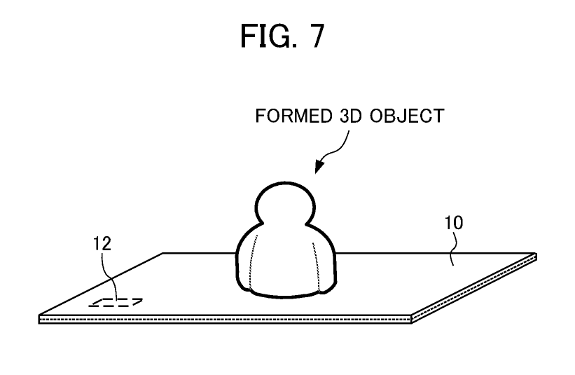

FIG. 7 is a schematic view illustrating a state in which a 3D object has been formed on the layering sheet 10 by the 3D-object production system 1.

In FIG. 7, a 3D object represented by formation data has been formed on the layering sheet 10 that is associated with the formation data by the identification information memorized in the RFID tag 12.
Thus, with the 3D object that is integrated with the layering sheet 10, the 3D object, which has value as an artefact, and the formation data, which has value as information incorporated in the 3D object, may be distributed in combination.
Therefore, by the 3D object being packaged with the formation data, added value may be produced in a variety of forms. When the formation data is embedded in the 3D object itself (a reference 3D-formed object R), the following are possible: copies may be produced with ease; if a portion of the 3D object is missing, data of the missing portion may be used to form that portion; a derivative object that is partially altered in accordance with objectives may be created by manipulating the formation data; and so forth.

As described above, according to the 3D-object production system 1 relating to the present embodiment, when the layering sheet 10 or reference 3D-formed object R equipped with the RFID tag is placed on the 3D-object production device 20, the 3D-object production device 20 reads the URL memorized in the RFID tag, accesses the server 30 corresponding to the URL, and acquires the formation data. Then, on the basis of the acquired formation data, the 3D-object production device 20 creates head control data, sequentially forms two-dimensional shapes of respective layers in accordance with the head control data, and layers the two-dimensional shapes. Thus, the 3D object is formed on the layering sheet 10. Therefore, a 3D object represented by formation data may be easily formed by the 3D-object production device 20 on the layering sheet 10 associated with the formation data. In other words, identification information representing an acquisition source of formation data is provided in the layering sheet 10, and the layering sheet 10 may be used for both the formed 3D object and the formation data.

Hence, the object produced by the 3D-object production device 20 may be distributed or the like to serve as a 3D-formed object that is equipped with formation data.
Alternatively, the 3D-object production device 20 may refer to the identification information provided in a reference 3D-formed object R and copy the 3D object in accordance with the formation data.
Thus, the usability of data to be used in the formation of a 3D object at the 3D-object production device 20 may be increased.

Because the layering sheet 10 relating to the present embodiment is equipped with the identification information representing the acquisition source of the formation data, the 3D object represented by the formation data may be effectively supplied by the formation data that is materially embodied in the layering sheet 10 being supplied in the state in which the 3D object has not been formed on the layering sheet 10. For example, formation data to be used in forming a 3D object that is a model of Mount Fuji may be prepared, identification information representing an acquisition source of this formation data may be adhered to a picture postcard of Mount Fuji that serves as the layering sheet 10, and this picture postcard may be sold.

A purchaser of the picture postcard may place the picture postcard on the 3D-object production device 20 and conduct formation. Thus, a 3D object that is a model of Mount Fuji may be supplied to the purchaser of the picture postcard. Thus, modes of use of the formation data may be expanded compared to the related art.

The reference 3D-formed object R relating to the present embodiment is equipped with its own formation data. Therefore, copies of the 3D object may be produced with ease. Thus, modes of use of the formation data may be expanded.

Because the formation data is managed by the database 31 of the server 30, the formation data of a 3D object may be modified (upgraded or the like) without any modification being applied to the identification information in the layering sheet 10, by the formation data memorized in the database 31 being modified as appropriate.

### Variant Example 1

In the embodiment described above, a case is described in which the 3D-object production device 20 is constituted by a Delta-type 3D printer. However, the structure of the 3D-object production device 20 is not particularly limited to a Delta-type 3D printer but may be an alternative kind of printer such as a three-axis 3D printer or the like.

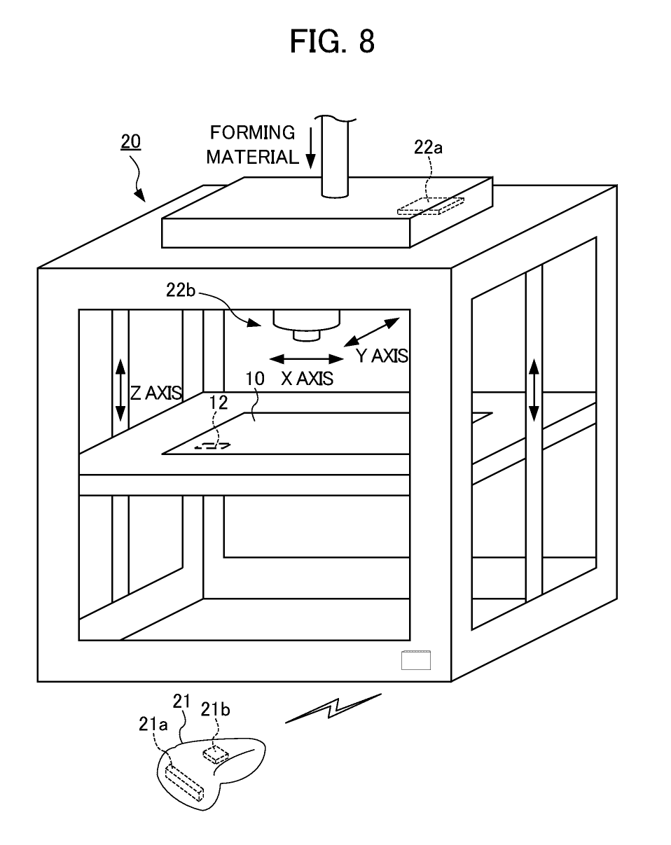

FIG. 8 is a schematic view illustrating an example in which the 3D-object production device 20 is constituted by a three-axis 3D printer.
The example illustrated in FIG. 8 is equipped with a barcode reader that serves as the ID reading device 21. The barcode reader is connected with the 3D-object production device 20 by wireless communications. In the structural example illustrated in FIG. 8, a URL is stored in a barcode at the layering sheet 10 or reference 3D formed object R. The 3D-object production device 20 may acquire the formation data by accessing the URL, which is read from the barcode by the ID reading device 21.

### Variant Example 2

In the above embodiment, a case is described in which the identification information is memorized in the RFID tag 12. However, the formation data itself may be memorized in the RFID tag 12.

In this case, the 3D-object production device 20 is not required to access the server 30 and the 3D object may be formed more easily.

### Variant Example 3

In the above embodiment, a limit may be applied to the number of 3D objects that can be produced using one of the layering sheet 10 or reference 3D-formed object in which the RFID tag 12 is incorporated.

In specific terms, a limit may be applied to the number of times the formation data corresponding to one set of identification information is supplied by the server 30 (a number of downloads). In this case, the server 30 memorizes the number of times the formation data corresponding to one set of identification information is supplied and, when a limit count has been reached, does not accept any more requests for the formation data. Alternatively, a number of requests to the server 30 for the formation data may be limited in accordance with the limit count by the 3D-object production device 20.
If the formation data itself is memorized in the RFID tag 12, the number of times layering formation is performed with the formation data read from the single RFID tag 12 may be managed by the 3D-object production device 20.
When the number of times of layering formation has reached the limit count, no more layering formation commands for that formation data are accepted.
In these cases, the limit count may be memorized in and read from the RFID tag 12 of the layering sheet 10 or reference 3D-formed object R. When the RFID tag 12 is read, a user may check the number of times that are still available. According to this mode, the number of a 3D object that can be formed may be managed even when the formation data has been distributed.

### Variant Example 4

In the above embodiment, as an alternative to the server 30 always supplying the same formation data as the formation data corresponding to the URL, different formation data may be supplied in accordance with pre-specified conditions such as the time of year and the like.

To be specific, if the 3D object that is formed is a model of a tree, the server 30 may supply formation data in accordance with the season, representing states of the tree in spring, summer, fall and winter, or the like.
Thus, the formation data that is supplied may be made more appropriate.

### Variant Example 5

In the above embodiment, a case is described in which the actual formation data of a 3D object is supplied from the server 30 to the 3D-object production device 20.

However, data enabling the formation of a 3D object may be supplied with the formation data itself being hidden. In specific terms, when there is a request from the 3D-object production device 20 for the transmission of formation data corresponding to identification information, the server 30 may process the formation data and supply the data in a format such as binary code of head control data for the 3D-object production device 20, or the like.
Thus, in the 3D-object production system 1, leaks of the formation data of 3D objects may be prevented even while production of the 3D objects on the basis of the formation data is realized.

### Variant Example 6

In the above embodiment, the layering sheet 10 or reference 3D-formed object R may be formed as a base for a specific purpose, and a URL of the formation data corresponding to that purpose may be memorized in the RFID tag 12.

For example, the layering sheet 10 or reference 3D-formed object R may be formed as a base for a miniature garden, and a URL of formation data for trees, a bridge and the like constituting the miniature garden may be memorized in the RFID tag 12.
In this case, after 3D objects have been formed on the layering sheet 10 or reference 3D-formed object R that is formed to be the base for the miniature garden, a saleable model or the like in which the miniature garden has been completed by further processing by a user may be produced. Thus, designability of the layering sheet 10 or reference 3D-formed object R may be increased and produced objects may be further improved.
As a further example, the layering sheet 10 or reference 3D-formed object R may be formed as a pedestal for a trophy or the like (a pedestal provided with ornamentation, text and the like), and a URL or the like of formation data for the main body of the trophy or the like may be memorized.
In this case, the pedestal associated with the formation data may be awarded instead of an actual trophy or the like. Hence, a user who has been awarded the pedestal may enjoy anticipating what form the 3D object will be formed in.

### Variant Example 7

In the above embodiment, access to the server 30 may be authenticated on the basis of the identification information in the layering sheet 10 or reference 3D formed object R. Thus, even if a third party learns the URL represented by the identification information, formation of the 3D object corresponding to the identification information by someone other than a user legitimately using the layering sheet 10 may be prevented.

The 3D-object production system 1 that is structured as described above is equipped with the layering sheet 10 or reference 3D-formed object R and the 3D-object production device 20.

The layering sheet 10 is provided with information pertaining to a 3D object and serves as a member used in the layering of the 3D object.
The reference 3D-formed object R serves as a reference 3D object equipped with information pertaining to the 3D object. The 3D-object production device 20 reads the information pertaining to the 3D object from the layering sheet 10 or the reference 3D-formed object R, and on the basis of the read information pertaining to the 3D object, layers and forms the 3D object.
Thus, when the layering sheet 10 or reference 3D-formed object R is placed in the 3D-object production device 20, the 3D-object production device 20 reads the information pertaining to the 3D object and forms the 3D object on the basis of the information pertaining to the 3D object.
Therefore, the 3D object represented by the information pertaining to the 3D object may be easily formed on the layering sheet 10 associated with the information pertaining to the 3D object.
Thus, an object produced by the 3D-object production device 20 may be distributed or the like as a 3D-formed object that is equipped with information pertaining to the 3D object. Alternatively, the 3D-object production device 20 may refer to the identification information provided in the reference 3D-formed object R and copy the 3D object in accordance with the formation data.
Thus, the usability of the formation data corresponding to the information pertaining to the 3D object may be increased in the 3D-object production device 20.

The 3D-object production system 1 further includes the server 30.

The server 30 supplies formation data to be used in the formation of a 3D object.
As the information pertaining to the 3D object, the layering sheet 10 or reference 3D-formed object R is provided with identification information that is an acquisition source of the formation data.
The 3D-object production device 20 acquires the formation data from the server 30 on the basis of the information pertaining to the 3D object that is read by the reading device 21. Thus, the formation data corresponding to the identification information provided in the layering sheet 10 or reference 3D-formed object R may be supplied by the server 30.
That is, the formation data may be managed by the server 30.

The server 30 may modify the formation data that is supplied in response to the information pertaining to the 3D object in accordance with a pre-specified condition.

Thus, the formation data that is supplied may be made more appropriate.

The server 30 may process the formation data into data in a different format with which the 3D object can be formed, and supply this data.

Thus, in the 3D-object production system 1, leaks of the formation data of 3D objects may be prevented even while production of the 3D objects on the basis of the formation data is realized.

The 3D-object production system 1 may limit the number of times a 3D object is produced on the basis of the information pertaining to the 3D object.

Therefore, the number of a 3D object that can be formed may be managed even when the formation data has been distributed.

As the information pertaining to a 3D object, the layering sheet 10 or reference 3D-formed object R may be equipped with formation data for forming the 3D object.

Thus, the 3D object may be formed at the 3D-object production device 20 more easily.

The present invention may be suitably modified, improved or the like within a scope that provides the effects of the present invention and is not limited to the embodiments described above.

For example, the layering sheet 10 is constituted by a sheet-shaped member, but is not limited to a sheet shape and may be constituted by a plate-shaped member, a block member or the like.
Further, a reference 3D-formed object R need not completely match the 3D object represented by the formation data. For example, the reference 3D-formed object may be a simple shape schematically illustrating the 3D object represented by the formation data, a shape in which ornamentation is applied to the 3D object represented by the formation data, or the like.
A case is described in which the mode by which the 3D-object production device 20 acquires the identification information provided at the layering sheet 10 or reference 3D-formed object R is via a USB cable, but this is not limiting. That is, the mode by which the 3D-object production device 20 acquires the identification information provided at the layering sheet 10 or reference 3D-formed object R may be any of various modes such as acquisition via the network 40 or the like. The above embodiment and variant examples may be combined as appropriate to embody the present invention.

The processing in the above embodiment may be executed by hardware or software.

That is, provided functions that can execute the processing described above are provided at the 3D-object production device 20 and the server 30, functional configurations and hardware configurations for realizing the functions are not limited to the examples described above.
In a case in which the above processing is to be executed by software, a program configuring the software is installed from a network or a storage medium into a computer.

A storage medium storing a program may be constituted by a removable medium that is distributed separately from the main body of the equipment, a storage medium that is incorporated in the main body of the equipment beforehand, or the like. The removable medium is constituted by, for example, a magnetic disc, an optical disc, a magneto-optical disc or the like. The optical disk is constituted by, for example, a CD-ROM (Compact Disc-Read Only Memory), a DVD (Digital Versatile Disc), a Blu-ray Disc (registered trademark) or the like. The magneto-optical disk is composed of an MD (Mini-Disk) or the like. A storage medium that is incorporated in the main body of the equipment is constituted by, for example, a ROM, a hard disc or the like in which the program is stored.

### EXPLANATION OF REFERENCE NUMERALS

1 3D-object production system; 10 layering sheet; 11a, 11b sheets; 12 RFID tag; 20 3D-object production device; 21 ID reading device; 21a reading section; 21b communications section; 22 3D-object forming unit; 22a head control data computation unit; 22b 3D printer head; 221b melting portion; 222b fan; 223b nozzle; 30 server; 31 database; 32 database management section; 40 network; R reference 3D-formed object

1. A 3D-object production system comprising:
at least one of a layering member to be used in layering of a 3D object, the layering member being provided with information pertaining to the 3D object, or a reference 3D object that is provided with the information pertaining to the 3D object; and
a 3D-object production device that reads the information pertaining to the 3D object from the layering member or reference 3D object and, on the basis of the read information pertaining to the 3D object, layers and forms the 3D object.

2. The 3D-object production system according to claim 1, further comprising a server that supplies formation data to be used in forming the 3D object,
wherein the layering member or reference 3D object is provided with, as the information pertaining to the 3D object, identification information representing an acquisition source of the formation data,
and the 3D-object production device acquires the formation data from the server on the basis of the read information pertaining to the 3D object.

3. The 3D-object production system according to claim 2, wherein the server modifies the formation data to be supplied in response to the information pertaining to the 3D object in accordance with a pre-specified condition.

4. The 3D-object production system according to claim 2, wherein the server processes the formation data into data of a different format, with which format the 3D object can be formed, and supplies this data.

5. The 3D-object production system according to claim 1, wherein a number of times the 3D object is produced is limited on the basis of the information pertaining to the 3D object.

6. The 3D-object production system according to claim 1, wherein the layering member or reference 3D object is provided with, as the information pertaining to the 3D object, formation data to be used in forming the 3D object.

7. A 3D-object production device comprising:
a reader that reads information pertaining to a 3D object from at least one of a layering member to be used in layering of the 3D object, the layering member being provided with the information pertaining to the 3D object, or a reference 3D object that is provided with the information pertaining to the 3D object; and
a former that, on the basis of the information pertaining to the 3D object read by the reader, layers and forms the 3D object.

8. A layering member to be used in layering of a 3D object by a 3D-object production device, comprising information pertaining to the 3D object, which information can be read by the 3D-object production device.

9. A 3D object to be referred to in layering of a 3D object by a 3D-object production device, comprising information pertaining to the 3D object, which information can be read by the 3D-object production device.

10. A 3D-object production method executed by a 3D-object production device, the method comprising:
reading information pertaining to a 3D object from at least one of a layering member to be used in layering of the 3D object, the layering member being provided with the information pertaining to the 3D object, or a reference 3D object that is provided with the information pertaining to the 3D object; and
layering and forming the 3D object on the basis of the read information pertaining to the 3D object.

11. A non-transitory computer-readable storage medium having stored thereon a computer-readable program that is executable by a computer controlling a 3D-object production device to cause the computer to perform functions comprising:
reading information pertaining to a 3D object from at least one of a layering member to be used in layering of the 3D object, the layering member being provided with the information pertaining to the 3D object, or a reference 3D object that is provided with the information pertaining to the 3D object; and
layering and forming the 3D object on the basis of the read information pertaining to the 3D object.
